(19) United States
(12) Patent Application Publication
(10) Pub. No.: US 2023/0154479 A1
(43) Pub. Date: May 18, 2023

(54) LOW COST ADAPTATION OF BASS POST-FILTER

(71) Applicant: Telefonaktiebolaget LM Ericsson (publ), Stockholm (SE)

(72) Inventors: Chamran MORADI ASHOUR, Stockholm (SE); Erik Norvell, Upplands Väsby (SE)

(21) Appl. No.: 17/918,289

(22) PCT Filed: Apr. 23, 2021
(86) PCT No.: PCT/EP2021/060643

§ 371 Date: Oct. 11, 2022

Related U.S. Application Data
(60) Provisional application No. 63/014,917, filed on Apr. 24, 2020.

(51) Int. Cl. G10L 19/26; G10L 25/51

(52) U.S. Cl. CPC G10L 19/26; G10L 25/51

(57) ABSTRACT

A method and a decoder for audio decoding, where an encoded primary signal is decoded to form a decoded primary signal, followed by a post-filtering of the decoded primary signal to form a post-filtered signal, where an output signal of the decoder is one of the decoded primary signal and the post-filtered signal. An energy estimation of at least a part of a frequency spectrum of the primary signal being reconstructed by the decoder and an analysis of discontinuities in time domain that is caused by the post-filtering of the decoded primary signal are obtained. A decision variable is generated based on the energy estimation and the analysis of discontinuities obtained. The decision variable is compared to a threshold and the output signal is set to be the decoded primary signal or the post-filtered signal based on the comparing of the decision variable to the threshold.

### TECHNICAL FIELD

The present disclosure relates generally to communications, and more particularly to methods and apparatuses for mono, stereo or multi-channel audio encoding and decoding.

### BACKGROUND

Although the capacity in telecommunication networks is continuously increasing, it is still of great interest to limit the required bandwidth per communication channel. In mobile networks smaller transmission bandwidths for each call yields lower power consumption in both the mobile device and the base station. This translates to energy and cost saving for the mobile operator, while the end user will experience prolonged battery life and increased talk-time. Further, with less consumed bandwidth per user, the mobile network can service a larger number of users in parallel.

In the field of speech coding, the ACELP (algebraic code-excited linear prediction) algorithm has been the leading technology in delivering high quality sound at low bit rates. In short, the ACELP model is composed of a linear predictor (LP) filter, which models the vocal tract and provides the coarse spectral shape of the reconstructed voice. The LP filter is driven by two codebooks: a pitch codebook (or adaptive codebook) which models the periodic component of the voice and an innovation codebook (or fixed codebook) which generates the non-periodic voice segments and also builds the pitch codebook. The core algorithm of the ACELP algorithm has been further enhanced, including post-processing tools such as post-filters. The two main such filters are the formant post-filter and the pitch-post filter, which both make use of parameters that are part of the ACELP speech model. The formant post-filter enhances the coarse spectral shape using the linear predictor filter (LP), and the pitch post-filter reduces inter-harmonic distortion by emphasizing the pitch period. A variant of the pitch post-filter, targeting the low frequency range, is the bass post-filter (BPF). This tool is present in recent speech codec standards, such as ITU-T G.718 and 3GPP EVS as illustrated in 3GPP TS 26.445 V16.0.0, Codec for Enhanced Voice Services (EVS); Detailed Algorithmic Description, 6.1.4.2 Bass post-filter [1].

Although the bass post-filter generally improves the quality of the decoded audio, it may have a negative impact on some signals. Several adaptation methods have been used to control the post-filter strength. In 3GPP EVS [1], the post-filter strength is adapted to how well the post-filtered signal correlates with the input signal. A low correlation suggests the filter may have a degrading impact, and as a result the filter output is attenuated. The post-filter strength is also adapted to the LP filter stability, where a low stability leads to an attenuated filter.

U.S. Pat. No. 9,224,403 describes further adaptation methods of the bass post-filter. Here, U.S. Pat. No. 9,224,403 has taken into consideration that the codec may use multiple modes, where the CELP or ACELP algorithm is one of these modes. Since the bass post-filter is only active for the ACELP mode, the strength of the bass post-filter may be adapted to avoid artefacts when enabling and disabling the filter in cases where there are frequent mode switches. U.S. Pat. No. 9,224,403 further considers how well the input signal is represented by the ACELP or CELP coding model. If there is significant energy loss, it is likely that the signal is not well modeled, and the bass post-filter may be harmful. To reduce the artefact from toggling the filter on and off, the post-filter strength may also be adapted gradually to give smoother transitions. The analysis of the filter impact may be done on a filter difference signal, describing the difference between the filtered and non-filtered signal. It may also be done on an approximate difference signal to reduce the computational complexity of the method.

In H. Chiba, et al “Adaptive Post-Filtering Controlled by Pitch Frequency for CELP-based Speech Coder”, 2014 48th Asilomar Conference on Signals, Systems and Computers, it is recognized that the suitability of the bass post-filter may depend on the pitch, or fundamental frequency, of the signal. Here, the post-filter strength is limited as a function of the pitch, such that post-filter is attenuated for lower frequencies. The output of the filter is also low-pass filtered with a cut-off frequency that depends on the fundamental frequency, yielding lower operating bandwidth for lower fundamental frequencies.

### SUMMARY

The post-filters are intended to reduce noise, but in some cases they may introduce new artefacts. In particular, abrupt changes in the parameters, such as a pitch period parameter or post-filter strength, may introduce discontinuities that become audible in the low energy regions of the spectrum.

Gradual activation and deactivation, as suggested by U.S. Pat. No. 9,224,403 B2, does not address the fact that discontinuities may happen internally in the filter as an effect of switching parameters. Experience shows that attempts to smoothen the transitions of the parameter switches may lead to a slower filter adaptation, which reduces the performance of the post-filter while the artefacts are still not fully removed.

In one aspect there is provided a method for audio decoding, where an encoded primary signal is decoded to form a decoded primary signal, followed by a post-filtering of the decoded primary signal to form a post-filtered signal, where an output signal of the decoder is one of the decoded primary signal and the post-filtered signal. An energy estimation of at least a part of a frequency spectrum of the primary signal being reconstructed by the decoder and an analysis of discontinuities in time domain that is caused by the post-filtering of the decoded primary signal are obtained. A decision variable is generated based on the energy estimation and the analysis of discontinuities obtained. The decision variable is compared to a threshold and the output signal is set to be the decoded primary signal or the post-filtered signal based on the comparing of the decision variable to the threshold.

In another aspect there is provided a decoder for audio decoding, where an encoded primary signal is decoded to form a decoded primary signal, followed by a post-filtering of the decoded primary signal to form a post-filtered signal, where an output signal of the decoder is one of the decoded primary signal and the post-filtered signal. The decoder comprises processing circuitry and memory coupled with the processing circuitry, wherein the memory includes instructions that when executed by the processing circuitry causes the decoder to perform operations comprising obtaining an energy estimation of at least a part of a frequency spectrum of the primary signal being reconstructed by the decoder and an analysis of discontinuities in time domain that is caused by the post-filtering of the decoded primary signal; generating a decision variable based on the energy estimation obtained and the analysis of discontinuities obtained; comparing the decision variable to a threshold and setting the output signal to be the decoded primary signal or the post-filtered signal based on the comparing of the decision variable to the threshold.

In another aspect there is provided a decoder adapted to perform operations comprising: obtaining an energy estimation of at least a part of a frequency spectrum of a primary signal being reconstructed by the decoder to form a decoded primary signal; obtaining an analysis of discontinuities in time domain that is caused by post-filtering of the decoded primary signal; generating a decision variable based on the energy estimation obtained and the analysis of discontinuities obtained; comparing the decision variable to a threshold; and setting the output signal to be the decoded primary signal or a post-filtered signal based on the comparing of the decision variable to the threshold.

In another aspect there is provided a computer program comprising program code to be executed by processing circuitry of a decoder, whereby execution of the program code causes the decoder to perform operations comprising: obtaining an energy estimation of at least a part of a frequency spectrum of a primary signal being reconstructed by the decoder to form a decoded primary signal; obtaining an analysis of discontinuities in time domain that is caused by post-filtering of the decoded primary signal; generating a decision variable based on the energy estimation obtained and the analysis of discontinuities obtained; comparing the decision variable to a threshold; and setting the output signal to be the primary signal decoded or a post-filtered signal based on the comparing of the decision variable to the threshold.

In another aspect there is provided a computer program product comprising a non-transitory storage medium including program code to be executed by processing circuitry of a decoder, whereby execution of the program code causes the decoder to perform operations comprising: obtaining an energy estimation of at least a part of a frequency spectrum of a primary signal being reconstructed by the decoder; obtaining an analysis of discontinuities in time domain that is caused by post-filtering of the primary signal; generating a decision variable based on the energy estimation obtained and the analysis of discontinuities obtained; comparing the decision variable to a threshold; and setting the output signal to be the primary signal decoded or the post-filtered signal based on the comparing of the decision variable to the threshold.

One advantage that may be obtained using the inventive concepts described herein is the addition of an adaptation of a post-filter such that the benefits of the post-filter are maintained, while the problematic cases are mitigated by attenuating or disabling the post-filter. Further, this advantage achieved by a low complex method which has a limited impact on the overall computational complexity of the audio decoder.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating an example of a decoder system operating in a network according to some embodiments;

FIG. 2 is a block diagram illustrating an example of a decoder with a pitch post-filter according to some embodiments;

FIG. 3 is an illustration of discontinuities that may appear at the subframe boundaries in a pitch post-filter adjustment signal;

FIG. 4 is an illustration of power spectra of a signal before and after applying the pitch post-filter called “bass post-filter (BPF)”;

FIG. 5 is a diagram illustrating a decoder with a pitch post-filter, where the decoder reconstructs the signal in frequency domain according to some embodiments;

FIG. 6 is a block diagram of the elements of an adaptive post-filter according to some embodiments of inventive concepts;

FIG. 7 is a block diagram illustrating elements of the adaptive post-filter according to some embodiments of inventive concepts;

FIG. 8 is a flowchart illustrating operations performed by an adaptive post-filter according to some embodiments of inventive concepts;

FIG. 9 is a block diagram illustrating the elements of an alternative adaptive post-filter according to some embodiments of inventive concepts;

FIG. 10 is a block diagram illustrating a decoder according to some embodiments of inventive concepts;

FIG. 11 is a flow chart illustrating operations of a decoder according to some embodiments of inventive concepts;

FIG. 12 is a flow chart illustrating operations of a decoder according to some embodiments of inventive concepts;

FIG. 13 is a flow chart illustrating operations of a decoder according to some embodiments of inventive concepts;

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

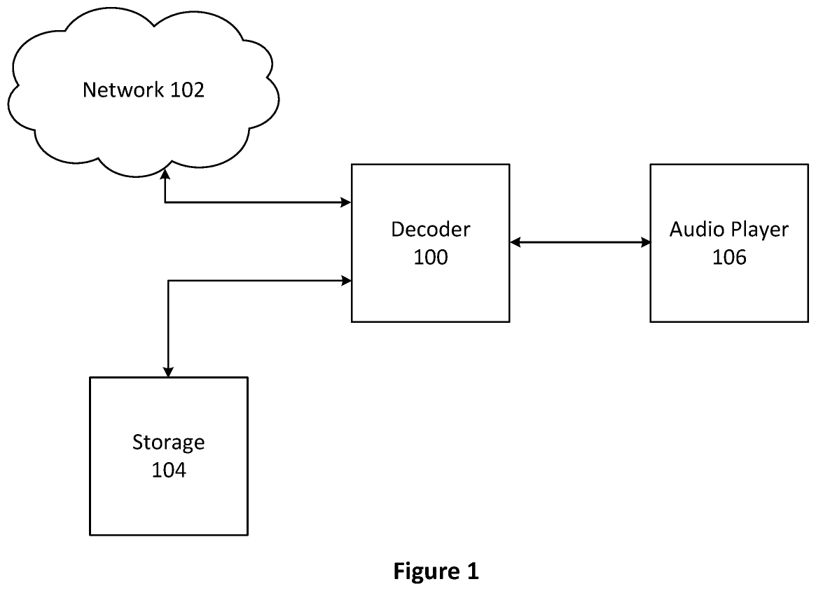

FIG. 1 illustrates an example of an operating environment of a decoder 100 that may be used to decode mono, stereo or multi-channel bitstreams as described herein. The decoder 100 may be part of a media player, a mobile device, a set-top device, a desktop computer, and the like. The decoder 100 receives encoded bitstreams. The bitstreams may be sent from an encoder, from a storage device 104, from a device on the cloud via network 102, etc. During operation, decoder 100 receives and processes the frames of the bitstream as described herein. The decoder 100 outputs audio signals (e.g., mono, stereo or multi-channel audio signals) and transmits the audio signals to an audio player 106 having at least one loudspeaker for playback of mono, stereo or multi-channel audio signals. Storage device 104 may be part of a storage depository of mono, stereo or multi-channel audio signals such as a storage repository of a store or a streaming music service, a separate storage component, a component of a mobile device, etc. An audio player may be a Bluetooth speaker, a device having at least one loudspeaker, a mobile device, a streaming music service, etc.

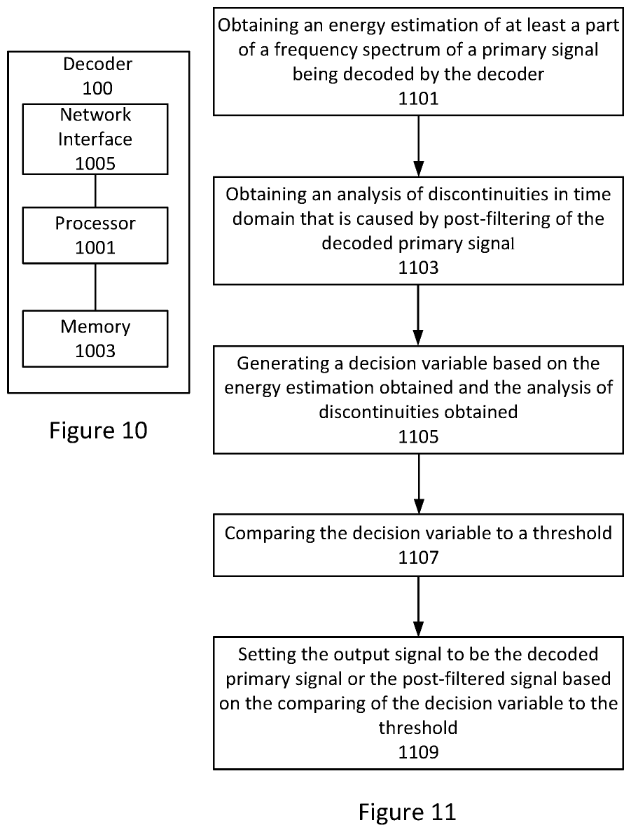

FIG. 10 is a block diagram illustrating elements of a decoder device 100 configured to provide wireless communication according to embodiments of inventive concepts. A decoder 100 may be part of a mobile terminal, a mobile communication terminal, a wireless communication device, a wireless terminal, a wireless communication terminal, user equipment, UE, a user equipment node/terminal/device, etc. As shown, decoder 100 may include a network interface circuit 1005, also referred to as a network interface, configured to provide communications with other devices/entities/functions/etc. The decoder 100 may also include a processor circuit 1001, also referred to as a processor, operatively coupled to the network interface circuit 1005, and a memory circuit 1003, also referred to as memory, operatively coupled to the processor circuit. The memory circuit 1003 may include computer readable program code that when executed by the processor circuit 1001 causes the processor circuit to perform operations according to embodiments disclosed herein.

According to other embodiments, processor circuit 1001 may be defined to include memory so that a separate memory circuit is not required. As discussed herein, operations of the decoder 100 may be performed by processor 1001 and/or network interface 1005. For example, processor 1001 may control network interface 1005 to transmit communications to multi-channel audio players and/or to receive communications through network interface 1005 from one or more other network nodes/entities/servers such as encoder nodes, depository servers, etc. Moreover, modules may be stored in memory 1003, and these modules may provide instructions so that when instructions of a module are executed by processor 1001, processor 1001 performs respective operations.

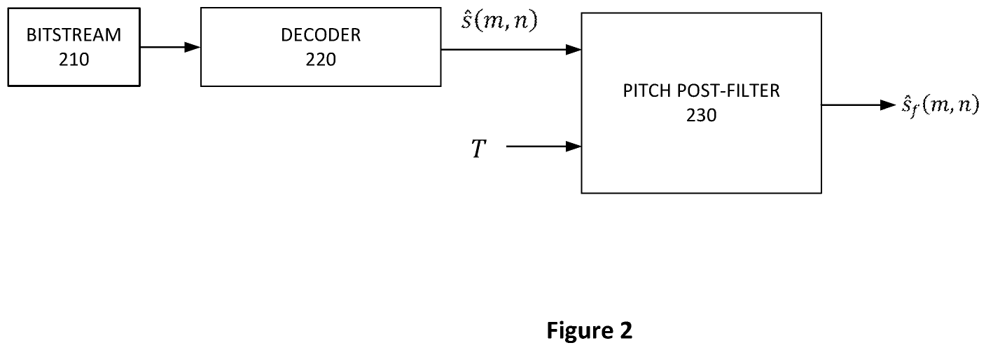

FIG. 2 illustrates an audio decoding system including a pitch post-filter. The decoder 220 receives a bitstream 210 from e.g. a transmission network or a storage medium. The decoder generates a reconstructed time domain signal ŝ(m,n) where n is the sample index and m is the frame number. The reconstructed time domain signal ŝ(m,n) may also be referred to as a primary signal or a decoded primary signal in the description that follows. The reconstructed time domain signal ŝ(m,n) is further enhanced by a pitch post-filter 230 which may also utilize a pitch period T.

The pitch period T is obtained through pitch analysis done on the decoded audio, or it may come from an analysis in the encoder or decoder on the target signal or a related audio signal which may have the same or similar dominant pitch as the post-filter input signal.

The post-filtered signal ŝ_{f}(m,n) may be derived using a pitch post-filter of the form:

$$\{ \begin{matrix}{\hat{s}}_{f} ( m , n ) = ( 1 - α ) \hat{s} ( m , n ) + α {s}_{p} ( m , n ) \\ {s}_{p} ( m , n ) = 0.5 \hat{s} ( m , n - T ) + 0.5 \hat{s} ( m , n + T )\end{matrix}$$

where T is the fundamental pitch period in samples and α∈[0, 0.5] controls the post-filter strength. An equivalent expression for the post-filtered signal is

ŝ_{f}(m,n)=ŝ(m,n)+α(sₚ(m,n)−ŝ(m,n))=ŝ(m,n)−α(ŝ(m,n)−sₚ(m,n))=ŝ(m,n)−s_{diff}(m,n)

where s_{diff}(m,n)=α(ŝ(m,n)−sₚ(m,n)) is the impact of the filter expressed as a negative difference signal or a correction signal or an error signal. The parameters α and T are typically updated each subframe, where a subframe may be 4 or 5 ms long. If the full audio frame is 20 ms, this means that the full frame is divided into 5 or 4 subframes respectively. In 3GPP EVS [1], the post-filter strength a is adapted based on the spectral stability of the signal. It also has a built-in failsafe mechanism by measuring the correlation with the post-filtered audio with the input signal. If the correlation is low, it means the filter is likely to have a negative impact on the quality and the filter is dampened or switched off.

The post-filtered signal ŝ_{f}(m,n) is output from the decoder system to be played back by an audio player or potentially stored or transmitted in a decoded PCM format. Note that the decoder system may include further processing of the post-filtered signal before the final signal is output, such as additional enhancements or combinations with other signals or signal components. The reconstructed signal may in such cases correspond to a difference signal, or residual signal, as outlined in ITU-T G.718 “Frame error robust narrow-band and wideband embedded variable bit-rate coding of speech and audio from 8-32 kbit/s”, section 7.14.1.2 Dual bass post-filter. The residual signal may be combined with another signal to provide an enhanced output signal.

### Bass Post-Filter Adaptation—Embodiment A

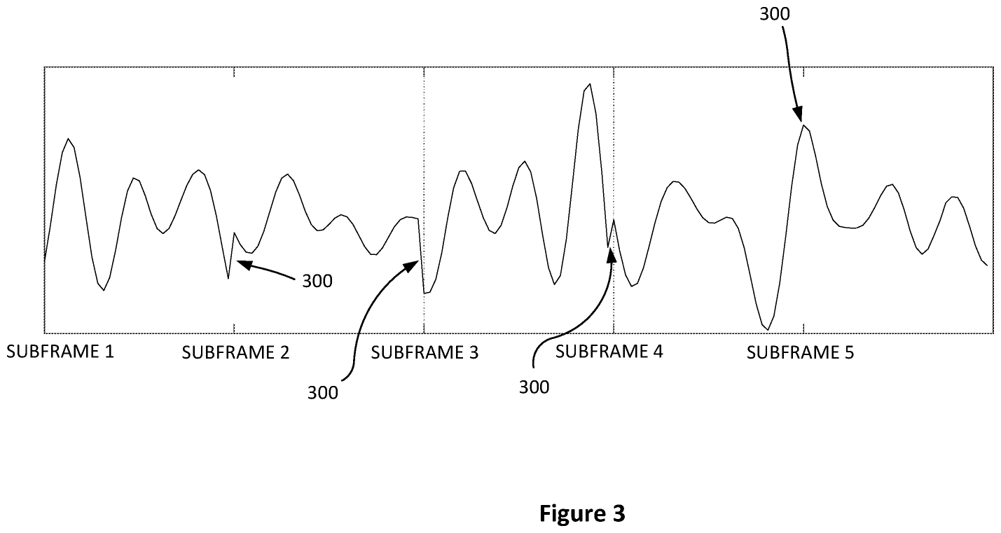

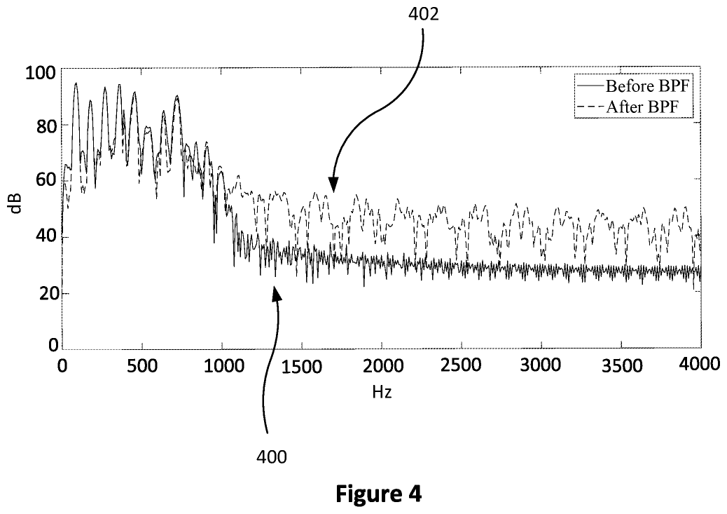

A drawback with the bass post-filter of FIG. 2 is that the abrupt change of the bass post-filter parameters at the subframe boundary may cause undesired discontinuities in the filtered signal, as illustrated by the discontinuities 300 in FIG. 3. These discontinuities may give distortions that spread across the frequency range. Depending on the spectrum of the input signal, these distortions may be noticeable and become disturbing. Consider e.g. the spectra 400 in FIG. 4, where the post-filter operation generates audible noise 402 above approximately 1 kHz. Note that the filter still has the desired effect below 200 Hz, where the inter-harmonic distortion is reduced.

The failsafe mechanism of the filter, which measures the correlation of the filter output with the filter input signal, does not address the problem of the subframe transitions. Since the correlation is computed within each subframe, the transitions between subframes and their potential impact has not been considered.

A possible technique to reduce the effects of the discontinuities is to apply smoothing through low-pass filtering the parameters or by cross-fading the post-filter output between subframes. Although such operations were found to reduce the artefacts, the operations also slowed down the adaptation of the filter such that the positive effects of the filter were reduced. Further, even though the low-pass filtering of the parameters reduced the artefacts, switching the post-filter off for these critical segments was found to be better. Hence, it seems desirable to keep the post-filter untouched for the regions where it has a positive impact while it should be switched off completely when it has a negative impact. An adaptation of the post-filter which can anticipate the distortions and disable the filter whenever needed can reduce and, in some embodiments, eliminate the effects of discontinuities.

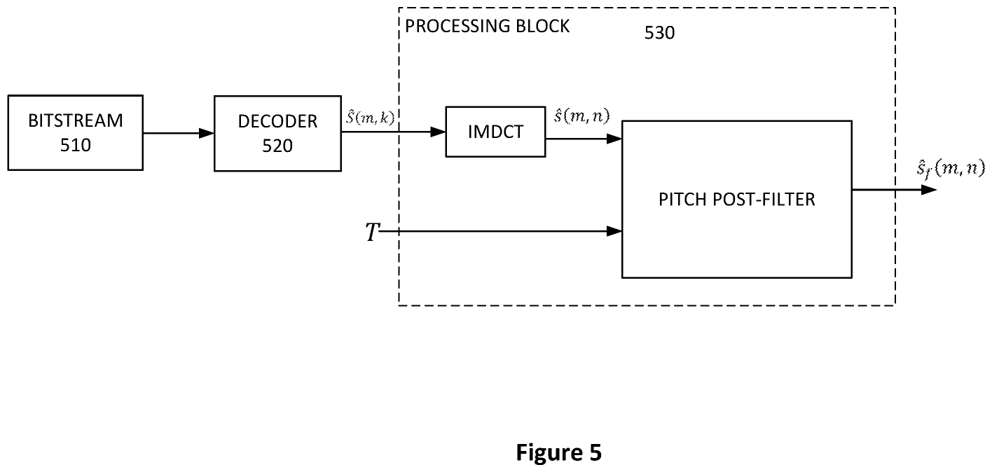

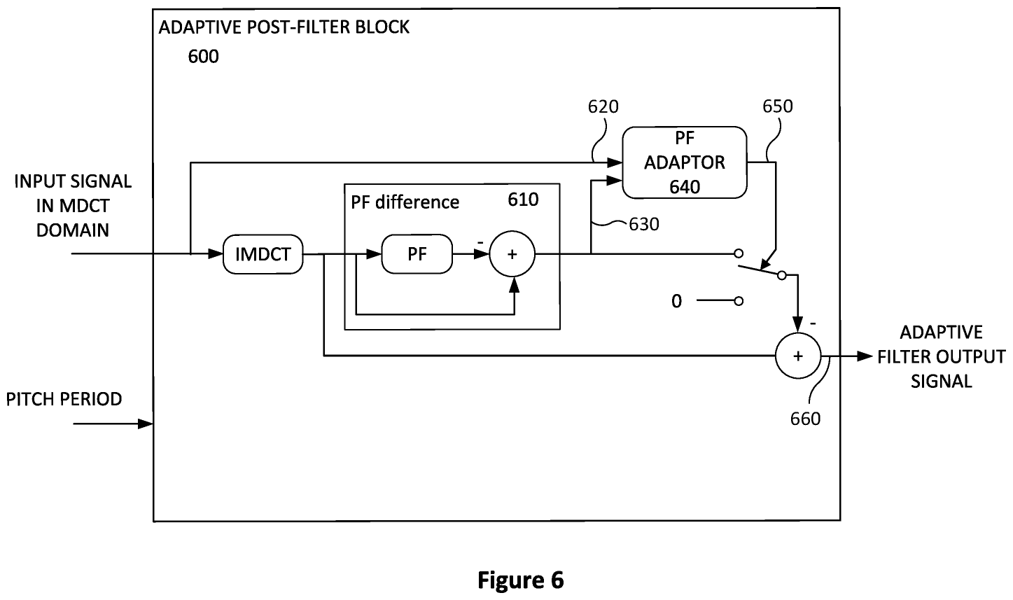

The decoder as outlined in FIG. 5 provides such an adaptation. The decoder 520 receives a bitstream 510 and produces a reconstructed signal Ŝ(m,k) in frequency domain where m is the frame number and k is the frequency bin index. A transform which is often used in audio encoder and decoder systems is MDCT (modified discrete cosine transform). It should be noted that the concepts presented herein are applicable for any transform domain where energy calculations are possible, such as DFT (discrete Fourier transform), QMF (quadrature mirror filterbank) or a Hybrid QMF filterbank. The processing block 530 performs the inverse MDCT (IMDCT) transform and applies the post-filter. A post-filter adaptation method according to some embodiments of inventive concepts can be described by substituting the processing block 530 of FIG. 5 with the adaptive post-filter block 600 of FIG. 6. The reconstructed signal 620 in frequency domain Ŝ(m,k) is transformed to time domain. The resulting time domain signal is input to a post-filter difference generating block 610. The post-filter difference s_{diff}(m,n) 630 and the reconstructed signal Ŝ(m,k) 620 in frequency domain are input to the post-filter adaptor 640, which forms a decision 650 whether or not the post-filter should be applied. The decision 650 is used to control the output 660 of the adaptive post-filter block by activating or deactivating subtraction of the post-filter difference from the reconstructed primary signal.

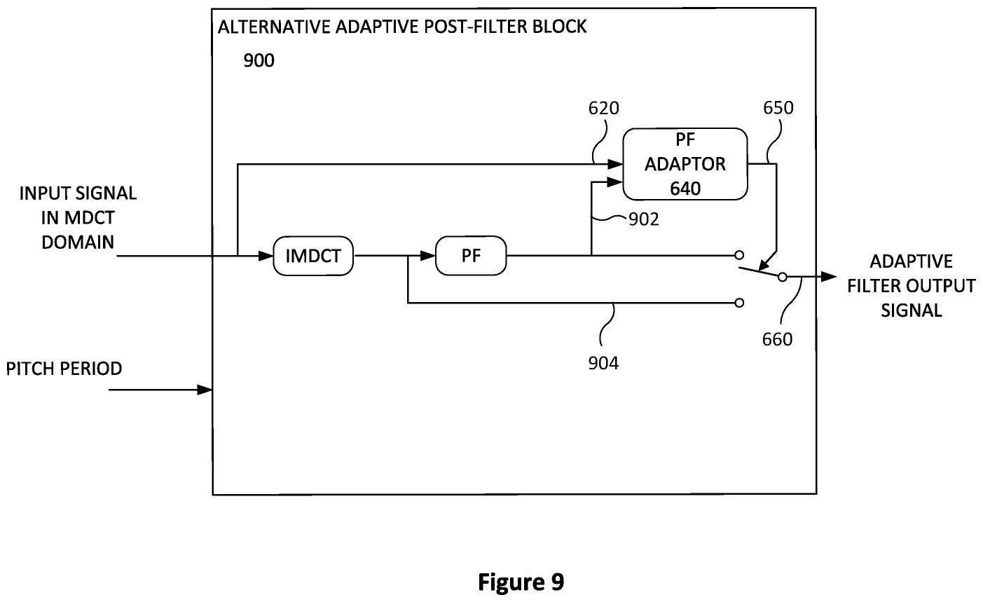

An alternative method, where the post-filter outputs the filtered signal rather than the filter difference signal is shown in FIG. 9. Here, the decision mechanism of alternative adaptive post-filter block 900 decides whether to use the filtered signal 902 or the non-filtered signal 904. The time domain analysis of the filtered signal is performed on the filtered signal 902 instead of the difference signal, which will obtain similar results.

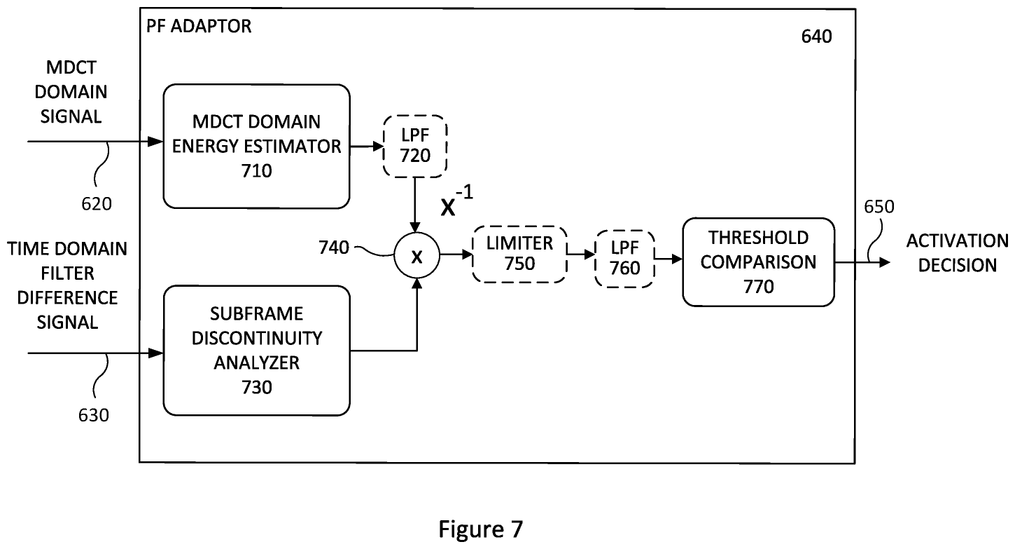

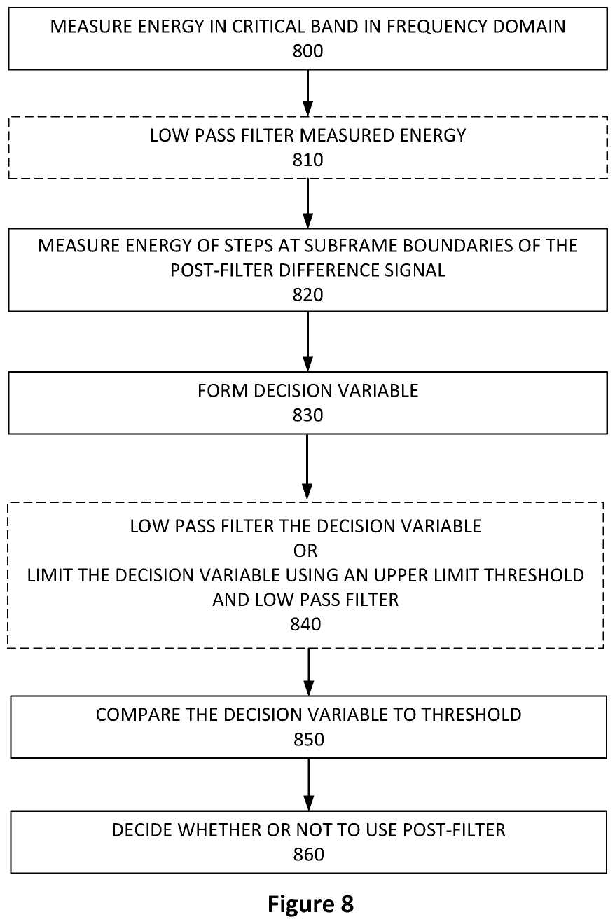

The post-filter adaptor 640 of FIG. 6 can be further described by the elements of FIG. 7 that perform the steps outlined in FIG. 8. Based on the analysis of the problematic items as illustrated in FIG. 3 and FIG. 4, a post-filter adaptation method may be based on detecting two conditions:
1. The spectrum has a strong tilt or a deep valley which may expose the potential distortion of a post-filter as illustrated in FIG. 4 where the signal 400 has a valley starting near 1000 Hz where the distortion 402 from the post filter is exposed, and
2. the discontinuities at the subframe boundaries are large as illustrated in FIG. 3 by discontinuities 300.

Detecting a strong tilt or a deep valley in the spectrum may be done by measuring the energy of the spectrum in a certain critical band. A low energy in the critical band could then indicate that a deep valley is found in a perceptually sensitive part of the spectrum. The energy measurement E_{Ŝ}_{_{cb}}(m) for each frame m may be done on the reconstructed signal Ŝ(m,k) in MDCT domain. The MDCT domain energy estimator 710 performs block 800 by measuring the energy of the critical band.

$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$

The frequency bin limits kₛₜₐᵣₜ and k_{end} can be set to match the frequency range of the critical band. For example, if the MDCT frame length N_{MDCT}=160, the sampling rate is 8000 Hz and the critical frequency range is 1000 Hz-1600 Hz, suitable values may be kₛₜₐᵣₜ=39 and k_{end}=64. For a strictly high-pass filtering operation, the upper limit should be 4000 Hz and k_{end}=160. In the description above, the critical band may be adaptive and e.g. depend on the reconstructed signal. The critical band could for instance be focused around an identified low energy region measured on a perceptual weighted spectrum. A perceptually weighted spectrum can be generated based on the spectrum of the reconstructed signal and transformed in frequency and level dimensions such that perceptually important regions are emphasized. An adaptive critical band can also take into consideration for which frequency range the post-filter may generate distortion.

Since the MDCT synthesis of Ŝ(m,k) may involve an overlap-add operation, it may be desirable to mimic the overlap-add in the energy estimation. This may be done by applying a low-pass FIR filter 720 in block 810 to the energy estimate:

\tilde{E}_{Ŝ}_{_{cb}}(m)=γE_{Ŝ}_{_{cb}}(m)+(1−γ)E_{Ŝ}_{_{cb}}(m−1).

Here γ∈(0,1] is a low-pass filtering coefficient which e.g. depends on the shape of the MDCT synthesis windows and the length of the overlap. A suitable value may be γ=0.61.

The size of the discontinuities is measured by averaging the step at the subframe boundaries of the filter difference signal s_{diff}(m,n) in block 820 using the subframe discontinuity analyzer 730:

$${\tilde{E}}_{step} ( m ) = \frac{1}{{N}_{sf}} {\sum }_{i = 1}^{{k}_{sf}} {( {s}_{diff} ( m , {n}_{i} ) - {s}_{diff} ( m , {n}_{i} - 1 ) )}^{2}$$

Where m denotes the frame number, i is the subframe number, N_{sf} is the number of subframes and n₁, n₂, . . . , n_{N}_{_{sf}} is the sample indices of the subframe boundaries marking the start of each new subframe. If the number of subframes N_{sf}=5 and the frame length N=160, the subframe boundary indices may be n₁=0, n₂=32, n₃=64, n₄=96, n₅=128. Note that for the first sample n₁=0, sample s_{diff}(m,−1) would be referenced. However, this is the same sample as the last sample of the previous frame, s_{diff}(m−1,N−1). In a practical implementation, this sample value would be stored in memory between frames.

A decision variable is formed at block 830 at multiplier 740 as the ratio between \tilde{E}ₛₜₑₚ(m) and \tilde{E}_{Ŝ}_{_{cb}}(m).

$${\tilde{E}}_{ratio} ( m ) = \frac{{\tilde{E}}_{step} ( m )}{{\tilde{E}}_{{\hat{S}}_{cb}} ( m )}$$

Alternatively, in case the optional low-pass filtering step 810 is omitted, a decision variable is formed as the ratio between \tilde{E}ₛₜₑₚ(m) and E_{Ŝ}_{_{cb}}(m), where E_{Ŝ}_{_{cb}}(m) is the energy estimate calculated in block 800.

To stabilize the decision, the \tilde{E}ᵣₐₜᵢₒ(m) may be low-pass filtered by applying a low-pass filter 760 at block 840 between frames, e.g.

\tilde{E}_{ratio,LP}(m)=β\tilde{E}ᵣₐₜᵢₒ(m)+(1−β)\tilde{E}_{ratio,LP}(m−1)

where β∈(0,1] is a low-pass filtering coefficient and a suitable value may be β=0.68.

It may further be beneficial to limit the range of the low-pass filtered energy ratio in block 840 via limiter 750, in which case the expression may be written

$${\tilde{E}}_{ratio , LP} ( m ) = β {\tilde{E}}_{ratio , 1} ( m ) + ( 1 - β ) {\tilde{E}}_{ratio , LP} ( m - 1 )$$

$${\tilde{E}}_{ratio , 1} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$

where E_{ratio,lim} would set an upper limit for the energy ratio and where a suitable value was found to be E_{ratio,lim}=2. Note that when β is 1, the energy ratio is no longer low-pass filtered.

The post-filter activation decision in various embodiments is taken by comparing the low-pass filtered energy ratio with the threshold at threshold comparator 770 in block 850 and determining whether or not to use (e.g., activate) the post-filter in block 860. In one embodiment of inventive concepts, the threshold Eₜₕᵣ is set to 1.

$$D ( m ) = \{ \begin{matrix}active , & {\tilde{E}}_{ratio , LP} ( m ) < {E}_{thr} \\ inactive , & {\tilde{E}}_{ratio , LP} ( m ) \geq {E}_{thr}\end{matrix}$$

where active indicates the post-filter is activated and inactive indicates the post-filter is disabled. It should be noted that if the optional block 840 is omitted, the decision variable \tilde{E}ᵣₐₜᵢₒ(m), calculated in block 830, is compared with the threshold. As indicated above, when the post-filter is activated, the output of the post-filter subtracts the post-filter difference from the reconstructed primary signal. When the post-filter is inactive, the output of the post-filter is the reconstructed primary signal.

Note that a similar analysis of the discontinuities may be done on the filter output signal s_{f}(m,n) instead of the difference signal s_{diff}(m,n), as illustrated in FIG. 9. This would likely lead to different choices on e.g. the filter constants β, γ, E_{ratio,lim} and Eₜₕᵣ, but the principles of the concepts described above would remain the same.

In some embodiments adding some hysteresis for the switching to reduce toggling may be useful if the low-pass filtered energy ratio is hovering around the threshold. One way to implement hysteresis is to have two thresholds: one for activation and one for deactivation. If the activation threshold is a bit higher than the deactivation threshold this creates a “dead zone” for the decision variable and reduces toggling if the variable is hovering around the threshold. Another way to implement hysteresis is to determine a count of the number of times the low-pass filtered energy ratio goes below (or alternatively, above) the threshold in a time period and activate (or deactivate) the post-filter after a predetermined number of times the low-pass filtered energy ratio goes below (or alternatively, above) the threshold in the time period.

In the embodiments described above, a critical band is used. In various other embodiments of inventive concepts, more than one critical band, corresponding to more than one spectral valley may be present. In one embodiment, the critical band selected to analyze is the most sensitive region and the decision whether or not to use the post-filter is performed for the selected critical band. In other embodiments, there could be multiple regions where the noise is just below the threshold for being noticeable, and combining many of these regions may result in a user hearing the noise while the analysis per region indicates the noise should not be noticeable. One way to account for this may be summing the contribution from several critical bands and deciding whether to set the output to be the primary signal or the post-filtered signal based on the embodiments described above. An alternative approach is to analyze the bands separately, and then disable the post-filter if the threshold is triggered for any one of the bands being analyzed.

### Embodiment B

An alternative method for deciding if the noise will be masked is to compare the energy of the signal in the critical region before and after the post-filter. This alternative method was found to give similar results as the inventive concepts described under Embodiment A, but at the cost of higher delay and complexity. The energy of critical band of the reconstructed signal can be measured in time domain:

$${E}_{{\hat{S}}_{cb}} ( m ) = \frac{1}{N} {\sum }_{n = 0}^{N - 1} {{\hat{s}}_{cb} ( m , n )}^{2}$$

$${\hat{s}}_{cb} ( m , n ) = {f}_{cb} ( \hat{s} ( m , n ) )$$

where f_{cb}(⋅) is a high-pass filter or a band-pass filter matching the critical band. Similarly, the energy of the critical band of the post-filtered reconstructed signal can be written

$${E}_{{s}_{f}} ( m ) = \frac{1}{N} {\sum }_{n = 0}^{N - 1} {{s}_{f , cb} ( m , n )}^{2}$$

$${s}_{f , cb} ( m , n ) = {f}_{cb} ( {s}_{f} ( m , n ) )$$

A decision D(m) to activate or disable the post-filter for frame m can be formed by comparing the energy ratio of the critical band of the signals before and after applying the post-filter to a decision threshold Eₜₕᵣ as illustrated below where active indicates the post-filter is activated and inactive indicates the post-filter is disabled. In one embodiment of inventive concepts, the threshold Eₜₕᵣ is set to 1. In other words, when the energy above a certain cut-off frequency is higher after applying the post-filter, the energy increase is assumed to be caused by noise and the post-filter is disabled.

$$D ( m ) = \{ \begin{matrix}active , & \frac{{E}_{{S}_{f}} ( m )}{{E}_{{\hat{S}}_{cb}} ( m )} < {E}_{thr} \\ inactive , & \frac{{E}_{{S}_{f}} ( m )}{{E}_{{\hat{S}}_{cb}} ( m )} \geq {E}_{thr}\end{matrix}$$

Disabling the post-filter for frame m can be implemented in some embodiments by using the decoded signal ŝ(m,n) instead of the post-filtered version s_{f}(m,n). If the filter routine produces a filter difference signal s_{diff}(m,n), the disabling of the filter can be implemented by skipping the subtraction of the filter difference signal from the decoded signal ŝ(m,n).

In some embodiments it may be useful to add some hysteresis for the switching between the primary signal and the post-filtered signal to reduce toggling if the energy ratio is hovering around the threshold. One way to implement hysteresis is to have two thresholds: one for activation and one for deactivation. If the activation threshold is a bit higher than the deactivation threshold this creates a “dead zone” for the decision variable and reduces toggling if the variable is hovering around the threshold. Another way to implement hysteresis is to determine a count of the number of times the low-pass filtered energy ratio goes below (or alternatively, above) the threshold in a time period and activate (or deactivate) the post-filter after a predetermined number of times the low-pass filtered energy ratio goes below (or alternatively, above) the threshold in the time period.

Operations of the decoder 100 (implemented using the structure of the block diagram of FIG. 10) will now be discussed with reference to the flow chart of FIG. 11 according to some embodiments of inventive concepts. For example, modules may be stored in memory 1003 of FIG. 3, and these modules may provide instructions so that when the instructions of a module are executed by respective communication device processing circuitry 1001, processing circuitry 1001 performs respective operations of the flow chart.

Turning now to FIG. 11, in block 1101, the processing circuitry 1001 obtains an energy estimation of at least a part of a frequency spectrum of the primary signal being reconstructed, i.e., decoded, by the decoder 100. The primary signal reconstruction may be done in the frequency domain. The operations of block 1101 are analogous to the operations of block 800 described above. In various embodiments of inventive concepts, the processing circuitry 1001 may obtain the energy estimation by summing energy coefficients of the at least a part of the frequency spectrum in the frequency domain. For example, in some embodiments, the processing circuitry 1001 obtains the energy estimation by measuring an energy of a critical band of a reconstructed signal in accordance with

$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$

wherein m is a frame number, E_{Ŝ}_{_{cb}}(m) is an energy of a critical band of the reconstructed signal, Ŝ(m,k) is a reconstructed signal, and frequency bin limits kₛₜₐᵣₜ and k_{end} are set to match a frequency range of critical band.

The processing circuitry 1001 may further process the measurement by applying a low-pass filter to the energy E_{Ŝ}_{_{cb}}(m) of the critical band of the reconstructed signal in accordance with

\tilde{E}_{Ŝ}_{_{cb}}(m)=γE_{Ŝ}_{_{cb}}(m)+(1−γ)E_{Ŝ}_{_{cb}}(m−1)

wherein γ∈(0, 1] and is a low-pass filtering coefficient which depends on a shape of modified discrete cosine transform, MDCT, synthesis windows and a length of an overlap.

In block 1103, the processing circuitry 1001 obtains an analysis of discontinuities in time domain that is caused by post-filtering of the primary signal. The operations of block 1103 are analogous to the operations of block 820 described above. In various embodiments of inventive concepts, the processing circuitry 1001 may obtain the analysis of the discontinuities in time domain by measuring an average energy of a size of the discontinuities. For example, in some embodiments, the processing circuitry 1001 measures the average energy of the size of the discontinuities by averaging a step at subframe boundaries of a filter difference signal s_{diff}(m,n) in accordance with

$${\tilde{E}}_{ratio} ( m ) = \frac{{\tilde{E}}_{step} ( m )}{{\tilde{E}}_{{\hat{S}}_{cb}} ( m )}$$

wherein m is a frame number, i is a subframe number, \tilde{E}ₛₜₑₚ(m) is an average energy of the step at the subframe boundaries, N_{sf} is a number of subframes and n₁, n₂, . . . , n_{N}_{_{sf}} are sample indices of the subframe boundaries marking the start of each subframe.

In block 1105, the processing circuitry 1001 generates a decision variable based on the energy estimation obtained and the analysis of discontinuities obtained. The operations of block 1105 are analogous to the operations of block 830 described above. In various embodiments of inventive concepts, the processing circuitry 1001 may generate the decision variable in accordance with

$${\tilde{E}}_{ratio} ( m ) = \frac{{\tilde{E}}_{step} ( m )}{{\tilde{E}}_{{\hat{S}}_{cb}} ( m )}$$

wherein \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of a critical band of a reconstructed signal.

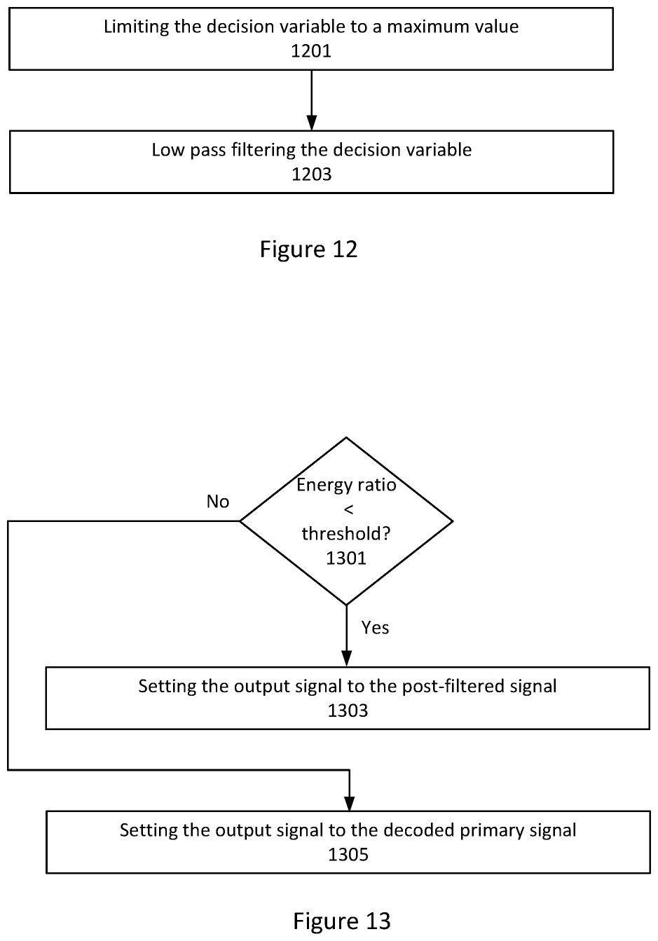

Turning to FIG. 12, in some embodiments of inventive concepts, the processing circuitry 1001 may limit the decision variable to a maximum value in block 1201 and low pass filter the decision variable in block 1203. The operations of blocks 1201 and 1203 are analogous to the operations of block 840 described above. In some embodiments, the processing circuitry 1001 limits the decision variable and low pass filters the decision variable in accordance with

$${\tilde{E}}_{ratio} ( m ) = \frac{{\tilde{E}}_{step} ( m )}{{\tilde{E}}_{{\hat{S}}_{cb}} ( m )} \\ {\tilde{E}}_{ratio , LP} ( m ) = β {\tilde{E}}_{ratio , 1} ( m ) + ( 1 - β ) {\tilde{E}}_{ratio , LP} ( m - 1 ) \\ {\tilde{E}}_{ratio , LP} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$

wherein m is a frame number, \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of a critical band of a reconstructed signal, β∈(0, 1] is a low-pass filtering coefficient, and E_{ratio,lim} is an upper limit for the energy ratio.

Returning to FIG. 11, in block 1107, the processing circuitry 1001 compares the decision variable to a threshold. For example, as described above, when the decision variable is the energy ratio between \tilde{E}ₛₜₑₚ(m) and \tilde{E}_{Ŝ}_{_{cb}}(m), the energy ratio is compared to a threshold Eₜₕᵣ.

In block 1109, the processing circuitry 1001 sets an output signal of the decoder 100 to the decoded primary signal or the post-filtered signal (formed by the post-filtering) based on the comparing of the decision variable to the threshold. For example, as described above, in some embodiments, the processing circuitry 1001 compares the decision variable in accordance with

$$D ( m ) = \{ \begin{matrix}active , \frac{{E}_{{S}_{f}} ( m )}{{E}_{{\hat{S}}_{cb}} ( m )} < {E}_{thr} \\ inactive , \frac{{E}_{{S}_{f}} ( m )}{{E}_{{\hat{S}}_{cb}} ( m )} \geq {E}_{thr}\end{matrix}$$

In various embodiments of inventive concepts, the threshold energy Eₜₕᵣ can be set to be a value of 1.

An example of setting the output signal is illustrated in FIG. 13. Turning to FIG. 13, the processing circuitry 1001 in block 1301 compares the energy ratio between an average energy of a step at subframe boundaries and an energy estimation of the at least a part of the frequency spectrum of the primary signal to a threshold.

In block 1303, responsive to the energy ratio between the average energy of the step at subframe boundaries and the energy estimation of the at least a part of the frequency spectrum of the primary signal being less than a threshold, the processing circuitry 1001 sets the output signal to be the post-filtered signal.

In block 1305, responsive to the energy ratio between the average energy of the step at subframe boundaries and the energy of the at least a part of the frequency spectrum of the primary signal being equal to the threshold or higher than the threshold, the processing circuitry 1001 sets the output signal to be the decoded primary signal.

In some embodiments of inventive concepts, hysteresis can be added for setting the output between the decoded primary signal and the post-filtered signal to reduce toggling if the energy ratio is hovering around the threshold.

Example embodiments are discussed below.

Embodiment 1. A method for audio decoding, where an encoded primary signal is decoded to form a decoded primary signal, followed by a post-filtering of the decoded primary signal to form a post-filtered signal, where an output signal of the decoder is one of the decoded primary signal and a post-filtered signal, the method comprising: obtaining (1101, 800) an energy estimation of at least a part of a frequency spectrum of the primary signal being reconstructed by the decoder; obtaining (1103, 820) an analysis of discontinuities in time domain that is caused by the post-filtering of the decoded primary signal; generating (1105, 830) a decision variable based on the energy estimation obtained and the analysis of discontinuities obtained; comparing (1107, 850) the decision variable to a threshold; and setting (1109) the output signal to be the decoded primary signal or the post-filtered signal based on the comparing of the decision variable to the threshold.

Embodiment 2. The method of Embodiment 1 wherein the primary signal reconstruction is done in frequency domain.

Embodiment 3. The method of Embodiment 2 wherein obtaining the energy estimation comprises summing energy coefficients of the at least a part of the frequency spectrum in the frequency domain.

Embodiment 4. The method of Embodiment 3 wherein obtaining the energy estimation comprises measuring an energy of a critical band of a reconstructed signal in accordance with

$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$

wherein m is a frame number, E_{Ŝ}_{_{cb}}(m) is an energy of a critical band of a reconstructed signal, Ŝ(m,k) is a reconstructed signal, and frequency bin limits kₛₜₐᵣₜ and k_{end} are set to match a frequency range of a critical band.

Embodiment 5. The method of Embodiment 4, further comprising applying a low-pass filter to the energy E_{Ŝ}_{_{cb}}(m) of the critical band of the reconstructed signal in accordance with

\tilde{E}_{Ŝ}_{_{cb}}(m)=γE_{Ŝ}_{_{cb}}(m)+(1−γ)E_{Ŝ}_{_{cb}}(m−1)

wherein γ∈(0, 1] and is a low-pass filtering coefficient which depends on a shape of modified discrete cosine transform, MDCT, synthesis windows and a length of an overlap.

Embodiment 6. The method of any of Embodiments 1-5 wherein obtaining the analysis of the discontinuities in time domain comprises measuring an average energy of a size of the discontinuities.

Embodiment 7. The method of Embodiment 6 wherein measuring the average energy of the size of the discontinuities comprises averaging a step at subframe boundaries of a filter difference signal s_{diff}(m,n) in accordance with

$${\tilde{E}}_{step} ( m ) = \frac{1}{{N}_{sf}} {\sum }_{i = 1}^{{N}_{sf}} {( {s}_{diff} ( m , {n}_{i} ) - {s}_{diff} ( m , {n}_{i} - 1 ) )}^{2}$$

wherein m is a frame number, i is a subframe number, \tilde{E}ₛₜₑₚ(m) is an average energy of the step at the subframe boundaries, N_{sf} is a number of subframes and n₁, n₂, . . . , n_{N}_{_{sf}} are sample indices of the subframe boundaries marking the start of each subframe.

Embodiment 8. The method of any of Embodiments 1-7 wherein generating the decision variable comprises limiting (1201, 840) the decision variable to a maximum value.

Embodiment 9. The method of any of Embodiments 1-8 further comprising low-pass filtering (1203, 840) the decision variable.

Embodiment 10. The method of Embodiment 9 wherein generating the decision variable comprises generating the decision variable \tilde{E}_{ratio,LP}(m) in accordance with

$${\tilde{E}}_{ratio} ( m ) = \frac{{\tilde{E}}_{step} ( m )}{{\tilde{E}}_{{\hat{S}}_{cb}} ( m )} \\ {\tilde{E}}_{ratio , LP} ( m ) = β {\tilde{E}}_{ratio , 1} ( m ) + ( 1 - β ) {\tilde{E}}_{ratio , LP} ( m - 1 ) \\ {\tilde{E}}_{ratio , LP} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$

wherein m is a frame number, \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of a critical band of a reconstructed signal, β∈(0, 1] is a low-pass filtering coefficient, and E_{ratio,lim} is an upper limit for the energy ratio.

Embodiment 11. The method of any of Embodiments 1-10, wherein setting the output signal to be the decoded primary signal or the post-filtered signal based on the comparing of the decision variable to the threshold comprises: responsive to an energy ratio between an average energy of a step at subframe boundaries and an energy estimation of the at least a part of the frequency spectrum of the primary signal being less than a threshold (1301), setting (1303) the output signal to the post-filtered signal; and responsive to the energy ratio between the average energy of the step at subframe boundaries and the energy of the at least a part of the frequency spectrum of the primary signal being equal to the threshold or higher than the threshold (1301), setting (1305) the output signal to the decoded primary signal.

Embodiment 12. The method of Embodiment 11, further comprising: providing hysteresis for the comparing of the decision variable to the threshold to prevent the output signal from being set back and forth between the primary signal and the post-filtered signal when the energy ratio goes above and below the threshold level in a specified period of time.

Embodiment 13. A decoder (100) for audio decoding, where a primary signal is decoded to form a decoded primary signal, followed by a post-filtering of the decoded primary signal to form a post-filtered signal, where an output signal of the decoder is one of the decoded primary signal and a post-filtered signal, the decoder comprising: processing circuitry (1001); and memory (1003) coupled with the processing circuitry, wherein the memory includes instructions that when executed by the processing circuitry causes the decoder to perform operations comprising: obtaining (1101, 800) an energy estimation of at least a part of a frequency spectrum of the primary signal being reconstructed by the decoder; obtaining (1103, 820) an analysis of discontinuities in time domain that is caused by the post-filtering of the decoded primary signal; generating (1105, 830) a decision variable based on the energy estimation obtained and the analysis of discontinuities obtained; comparing (1107, 850) the decision variable to a threshold; and setting (1109) the output signal to be the decoded primary signal or the post-filtered signal based on the comparing of the decision variable to the threshold.

Embodiment 14. The decoder of Embodiment 13 wherein a primary signal reconstruction is done in frequency domain.

Embodiment 15. The decoder of Embodiment 14 wherein in obtaining the energy estimation, the memory includes further instructions that when executed by the processing circuitry causes the decoder to perform operations comprising summing energy coefficients of the at least a part of the frequency spectrum in the frequency domain.

Embodiment 16. The decoder of Embodiment 15 wherein in obtaining the energy estimation, the memory includes further instructions that when executed by the processing circuitry causes the decoder to perform operations comprising measuring an energy of a critical band of a reconstructed signal in accordance with

$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$

wherein m is a frame number, E_{Ŝ}_{_{cb}}(m) is the energy of the critical band of the reconstructed signal, Ŝ(m,k) is a reconstructed signal, and frequency bin limits kₛₜₐᵣₜ and k_{end} are set to match a frequency range of the critical band.

Embodiment 17. The decoder of Embodiment 16, wherein the memory includes further instructions that when executed by the processing circuitry causes the decoder to perform further operations comprising applying a low-pass filter to the energy E_{Ŝ}_{_{cb}}(m) of the critical band of the reconstructed signal in accordance with

\tilde{E}_{Ŝ}_{_{cb}}(m)=γE_{Ŝ}_{_{cb}}(m)+(1−γ)E_{Ŝ}_{_{cb}}(m−1)

wherein γ∈(0, 1] and is a low-pass filtering coefficient which depends on a shape of modified discrete cosine transform, MDCT, synthesis windows and a length of an overlap.

Embodiment 18. The decoder of any of Embodiments 13-17 wherein in obtaining the analysis of the discontinuities in time domain, the memory includes further instructions that when executed by the processing circuitry causes the decoder to perform operations comprising measuring an average energy of a size of the discontinuities.

Embodiment 19. The decoder of any of Embodiments 13-18 wherein in measuring the average energy of the size of the discontinuities, the memory includes further instructions that when executed by the processing circuitry causes the decoder to perform operations comprising averaging a step at subframe boundaries of a filter difference signal s_{diff}(m,n) in accordance with

$${\tilde{E}}_{step} ( m ) = \frac{1}{{N}_{sf}} {\sum }_{i = 1}^{{N}_{sf}} {( {s}_{diff} ( m , {n}_{i} ) - {s}_{diff} ( m , {n}_{i} - 1 ) )}^{2}$$

wherein m is a frame number, i is a subframe number, \tilde{E}ₛₜₑₚ(m) is an average energy of the step at the subframe boundaries, N_{sf} is a number of subframes and n₁, n₂, . . . , n_{N}_{_{sf}} are sample indices of the subframe boundaries marking the start of each subframe.

Embodiment 20. The decoder of any of Embodiments 13-19 wherein in generating the decision variable, the memory includes further instructions that when executed by the processing circuitry causes the decoder to perform operations comprising limiting (1201, 840) the decision variable to a maximum value.

Embodiment 21. The decoder of any of Embodiments 13-20 wherein the memory includes further instructions that when executed by the processing circuitry causes the decoder to perform operations comprising low-pass filtering (1203, 840) the decision variable.

Embodiment 22. The decoder of Embodiment 21 wherein in generating the decision variable, the memory includes further instructions that when executed by the processing circuitry causes the decoder to perform operations comprising generating the decision variable \tilde{E}_{ratio,LP}(m) in accordance with

$${\tilde{E}}_{ratio} ( m ) = \frac{{\tilde{E}}_{step} ( m )}{{\tilde{E}}_{{\hat{S}}_{cb}} ( m )} \\ {\tilde{E}}_{ratio , LP} ( m ) = β {\tilde{E}}_{ratio , 1} ( m ) + ( 1 - β ) {\tilde{E}}_{ratio , LP} ( m - 1 ) \\ {\tilde{E}}_{ratio , LP} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$

wherein m is a frame number, \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of the critical band of the reconstructed signal, β∈(0, 1] is a low-pass filtering coefficient, and E_{ratio,lim} is an upper limit for the energy ratio.

Embodiment 23. The decoder of any of Embodiments 13-22, wherein in setting the output signal to be the primary signal or the post-filtered signal based on the comparing of the decision variable to the threshold, the memory includes further instructions that when executed by the processing circuitry causes the decoder to perform operations comprising: responsive to an energy ratio between an average energy of a step at subframe boundaries and an energy estimation of the at least a part of the frequency spectrum of the primary signal being less than a threshold (1301), setting (1303) the output signal to the post-filtered signal; and responsive to the energy ratio between the average energy of the step at subframe boundaries and the energy of the at least a part of the frequency spectrum of the primary signal being equal to the threshold or higher than the threshold (1301), setting (1305) the output signal to the decoded primary signal.

Embodiment 24. The decoder of Embodiment 23, wherein the memory includes further instructions that when executed by the processing circuitry causes the decoder to perform further operations comprising: providing hysteresis for the comparing of the decision variable to the threshold to prevent the output signal from being set back and forth between the primary signal and the post-filtered signal when the energy ratio goes above and below the threshold level in a specified period of time.

Embodiment 25. A decoder (100) adapted to perform operations comprising: obtaining (1101, 800) an energy estimation of at least a part of a frequency spectrum of a primary signal being reconstructed by the decoder to form a decoded primary signal; obtaining (1103, 820) an analysis of discontinuities in time domain that is caused by post-filtering of the decoded primary signal; generating (1105, 830) a decision variable based on the energy estimation obtained and the analysis of discontinuities obtained; comparing (1107, 850) the decision variable to a threshold; and setting (1109) the output signal to be the decoded primary signal or a post-filtered signal based on the comparing of the decision variable to the threshold.

Embodiment 26. The decoder (100) of Embodiment 25, wherein the decoder (100) is adapted to perform operations according to any of Embodiments 2-12.

Embodiment 27. A computer program comprising program code to be executed by processing circuitry (1001) of a decoder (100), whereby execution of the program code causes the decoder (100) to perform operations comprising: obtaining (1101, 800) an energy estimation of at least a part of a frequency spectrum of a primary signal being reconstructed by the decoder to form a decoded primary signal; obtaining (1103, 820) an analysis of discontinuities in time domain that is caused by post-filtering of the decoded primary signal; generating (1105, 830) a decision variable based on the energy estimation obtained and the analysis of discontinuities obtained; comparing (1107, 850) the decision variable to a threshold; and setting (1109) the output signal to be the primary signal decoded or a post-filtered signal based on the comparing of the decision variable to the threshold.

Embodiment 28. The computer program of Embodiment 27 comprising further program code, whereby execution of the program code causes the decoder (100) to perform operations according to any of Embodiments 2-12.

Embodiment 29. A computer program product comprising a non-transitory storage medium including program code to be executed by processing circuitry (1001) of a decoder (100), whereby execution of the program code causes the decoder (100) to perform operations comprising: obtaining (1101, 800) an energy estimation of at least a part of a frequency spectrum of a primary signal being reconstructed by the decoder; obtaining (1103, 820) an analysis of discontinuities in time domain that is caused by post-filtering of the primary signal; generating (1105, 830) a decision variable based on the energy estimation obtained and the analysis of discontinuities obtained; comparing (1107, 850) the decision variable to a threshold; and setting (1109) the output signal to be the primary signal decoded or the post-filtered signal based on the comparing of the decision variable to the threshold.

Embodiment 30. The computer program product of Embodiment 29 wherein the non-transitory storage medium includes further program code, whereby execution of the further program code causes the decoder (100) to perform operations according to any of Embodiments 2-12.

Explanations are provided below for various abbreviations/acronyms used in the present disclosure.

| Abbreviation | Explanation |
|---|---|
| BPF | Bass Post-Filter |
| DFT | Discrete Fourier Transform |
| MDCT | Modified Discrete Cosine Transform |
| EVS | Enhanced Voice Service |
| QMF | Quadrature Mirror Filterbank |

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method for audio decoding, where an encoded primary signal is decoded to form a decoded primary signal, followed by a post-filtering of the decoded primary signal to form a post-filtered signal, where an output signal of the decoder is one of the decoded primary signal and the post-filtered signal, the method comprising:
obtaining an energy estimation of at least a part of a frequency spectrum of the primary signal being reconstructed by the decoder;
obtaining an analysis of discontinuities in time domain that is caused by the post-filtering of the decoded primary signal;
generating a decision variable based on the energy estimation obtained and the analysis of discontinuities obtained;
comparing the decision variable to a threshold; and
setting the output signal to be the decoded primary signal or the post-filtered signal based on the comparing of the decision variable to the threshold.

2. The method of claim 1, wherein the primary signal reconstruction is done in frequency domain.

3. The method of claim 2, wherein obtaining the energy estimation comprises summing energy coefficients of the at least a part of the frequency spectrum in the frequency domain.

4. The method of claim 3, wherein obtaining the energy estimation comprises measuring an energy of a critical band of a reconstructed signal in accordance with
$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$
wherein m is a frame number, E_{Ŝ}_{_{cb}}(m) is an energy of a critical band of a reconstructed signal, Ŝ(m,k) is a reconstructed signal, and frequency bin limits kₛₜₐᵣₜ and k_{end} are set to match a frequency range of a critical band.

5. The method of claim 4, further comprising applying a low-pass filter to the energy E_{Ŝ}_{_{cb}}(m) of the critical band of the reconstructed signal in accordance with
\tilde{E}_{Ŝ}_{_{cb}}(m)=γE_{Ŝ}_{_{cb}}(m)+(1−γ)E_{Ŝ}_{_{cb}}(m−1)
wherein γ∈(0, 1] and is a low-pass filtering coefficient which depends on a shape of modified discrete cosine transform, MDCT, synthesis windows and a length of an overlap.

6. The method of claim 1, wherein obtaining the analysis of the discontinuities in time domain comprises measuring an average energy of a size of the discontinuities.

7. The method of claim 6, wherein measuring the average energy of the size of the discontinuities comprises averaging a step at subframe boundaries of a filter difference signal s_{diff}(m,n) in accordance with
$${\tilde{E}}_{step} ( m ) = \frac{1}{{N}_{sf}} {\sum }_{i = 1}^{{N}_{sf}} {( {s}_{diff} ( m , {n}_{i} ) - {s}_{diff} ( m , {n}_{i} - 1 ) )}^{2}$$
wherein m is a frame number, i is a subframe number, \tilde{E}ₛₜₑₚ(m) is an average energy of the step at the subframe boundaries, N_{sf} is a number of subframes and n₁, n₂, . . . , n_{N}_{_{sf}} are sample indices of the subframe boundaries marking the start of each subframe.

8. The method of claim 1, wherein generating the decision variable comprises limiting the decision variable to a maximum value.

9. The method of claim 1, further comprising low-pass filtering the decision variable.

10. The method of claim 9, wherein generating the decision variable comprises generating the decision variable \tilde{E}_{ratio,LP}(m) in accordance with
$${\tilde{E}}_{ratio} ( m ) = \frac{{\tilde{E}}_{step} ( m )}{{\tilde{E}}_{{\hat{S}}_{cb}} ( m )} \\ {\tilde{E}}_{ratio , LP} ( m ) = β {\tilde{E}}_{ratio , 1} ( m ) + ( 1 - β ) {\tilde{E}}_{ratio , LP} ( m - 1 ) \\ {\tilde{E}}_{ratio , LP} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$
wherein m is a frame number, \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of a critical band of a reconstructed signal, β∈(0, 1] is a low-pass filtering coefficient, and E_{ratio,lim} is an upper limit for the energy ratio.

11. The method of claim 1, wherein setting the output signal to be the decoded primary signal or the post-filtered signal based on the comparing of the decision variable to the threshold comprises:
responsive to an energy ratio between an average energy of a step at subframe boundaries and an energy estimation of the at least a part of the frequency spectrum of the primary signal being less than a threshold,
setting the output signal to the post-filtered signal; and
responsive to the energy ratio between the average energy of the step at subframe boundaries and the energy of the at least a part of the frequency spectrum of the primary signal being equal to the threshold or higher than the threshold, setting the output signal to the decoded primary signal.

12. The method of claim 11, further comprising: providing hysteresis for the comparing of the decision variable to the threshold to prevent the output signal from being set back and forth between the primary signal and the post-filtered signal when the energy ratio goes above and below the threshold level in a specified period of time.

13. A decoder for audio decoding, where an encoded primary signal is decoded to form a decoded primary signal, followed by a post-filtering of the decoded primary signal to form a post-filtered signal, where an output signal of the decoder is one of the decoded primary signal and the post-filtered signal, the decoder comprising:
processing circuitry; and
memory coupled with the processing circuitry, wherein the memory includes instructions that when executed by the processing circuitry causes the decoder to perform operations comprising:
obtaining an energy estimation of at least a part of a frequency spectrum of the primary signal being reconstructed by the decoder;
obtaining an analysis of discontinuities in time domain that is caused by the post-filtering of the decoded primary signal;
generating a decision variable based on the energy estimation obtained and the analysis of discontinuities obtained;
comparing the decision variable to a threshold; and
setting the output signal to be the decoded primary signal or the post-filtered signal based on the comparing of the decision variable to the threshold.

14. The decoder of claim 13, wherein a primary signal reconstruction is done in frequency domain.

15. The decoder of claim 14, wherein in obtaining the energy estimation, the memory includes further instructions that when executed by the processing circuitry causes the decoder to perform operations comprising summing energy coefficients of the at least a part of the frequency spectrum in the frequency domain.

16. The decoder of claim 15, wherein in obtaining the energy estimation, the memory includes further instructions that when executed by the processing circuitry causes the decoder to perform operations comprising measuring an energy of a critical band of a reconstructed signal in accordance with
$${E}_{{\hat{S}}_{cb}} ( m ) = \frac{1}{{k}_{end} - {k}_{start} + 1} {\sum }_{k = {k}_{start}}^{{k}_{end}} {( \hat{S} ( m , k ) )}^{2}$$
wherein m is a frame number, E_{Ŝ}_{_{cb}}(m) is the energy of the critical band of the reconstructed signal, Ŝ(m,k) is a reconstructed signal, and frequency bin limits kₛₜₐᵣₜ and k_{end} are set to match a frequency range of the critical band.

17. The decoder of claim 16, wherein the memory includes further instructions that when executed by the processing circuitry causes the decoder to perform further operations comprising applying a low-pass filter to the energy E_{Ŝ}_{_{cb}}(m) of the critical band of the reconstructed signal in accordance with
\tilde{E}_{Ŝ}_{_{cb}}(m)=γE_{Ŝ}_{_{cb}}(m)+(1−γ)E_{Ŝ}_{_{cb}}(m−1)
wherein γ∈(0, 1] and is a low-pass filtering coefficient which depends on a shape of modified discrete cosine transform, MDCT, synthesis windows and a length of an overlap.

18. The decoder of claim 13, wherein in obtaining the analysis of the discontinuities in time domain, the memory includes further instructions that when executed by the processing circuitry causes the decoder to perform operations comprising measuring an average energy of a size of the discontinuities.

19. The decoder of claim 13, wherein in measuring the average energy of the size of the discontinuities, the memory includes further instructions that when executed by the processing circuitry causes the decoder to perform operations comprising averaging a step at subframe boundaries of a filter difference signal s_{diff}(m,n) in accordance with
$${\tilde{E}}_{step} ( m ) = \frac{1}{{N}_{sf}} {\sum }_{i = 1}^{{N}_{sf}} {( {s}_{diff} ( m , {n}_{i} ) - {s}_{diff} ( m , {n}_{i} - 1 ) )}^{2}$$
wherein m is a frame number, i is a subframe number, \tilde{E}ₛₜₑₚ(m) is an average energy of the step at the subframe boundaries, N_{sf} is a number of subframes and n₁, n₂, . . . , n_{N}_{_{sf}} are sample indices of the subframe boundaries marking the start of each subframe.

20. The decoder of claim 13, wherein in generating the decision variable, the memory includes further instructions that when executed by the processing circuitry causes the decoder to perform operations comprising limiting the decision variable to a maximum value.

21. The decoder of claim 13, wherein the memory includes further instructions that when executed by the processing circuitry causes the decoder to perform operations comprising low-pass filtering the decision variable.

22. The decoder of claim 21, wherein in generating the decision variable, the memory includes further instructions that when executed by the processing circuitry causes the decoder to perform operations comprising generating the decision variable \tilde{E}_{ratio,LP}(m) in accordance with
$${\tilde{E}}_{ratio} ( m ) = \frac{{\tilde{E}}_{step} ( m )}{{\tilde{E}}_{{\hat{S}}_{cb}} ( m )} \\ {\tilde{E}}_{ratio , LP} ( m ) = β {\tilde{E}}_{ratio , 1} ( m ) + ( 1 - β ) {\tilde{E}}_{ratio , LP} ( m - 1 ) \\ {\tilde{E}}_{ratio , LP} ( m ) = \{ \begin{matrix}{\tilde{E}}_{ratio} ( m ) , & {\tilde{E}}_{ratio} ( m ) \leq {E}_{ratio , lim} \\ {E}_{ratio , lim} , & {\tilde{E}}_{ratio} ( m ) > {E}_{ratio , lim}\end{matrix}$$
wherein m is a frame number, \tilde{E}ᵣₐₜᵢₒ(m) is an energy ratio between \tilde{E}ₛₜₑₚ(m) and \tilde{E}_{Ŝ}_{_{cb}}(m), \tilde{E}ₛₜₑₚ(m) is an average energy of a step at subframe boundaries, \tilde{E}_{Ŝ}_{_{cb}}(m) is a low-pass filtered energy E_{Ŝ}_{_{cb}}(m) of the critical band of the reconstructed signal, β∈(0, 1] is a low-pass filtering coefficient, and E_{ratio,lim} is an upper limit for the energy ratio.

23. The decoder of claim 13, wherein in setting the output signal to be the primary signal or the post-filtered signal based on the comparing of the decision variable to the threshold, the memory includes further instructions that when executed by the processing circuitry causes the decoder to perform operations comprising:
responsive to an energy ratio between an average energy of a step at subframe boundaries and an energy estimation of the at least a part of the frequency spectrum of the primary signal being less than a threshold, setting the output signal to the post-filtered signal; and
responsive to the energy ratio between the average energy of the step at subframe boundaries and the energy of the at least a part of the frequency spectrum of the primary signal being equal to the threshold or higher than the threshold, setting the output signal to the decoded primary signal.

24. The decoder of claim 23, wherein the memory includes further instructions that when executed by the processing circuitry causes the decoder to perform further operations comprising:
providing hysteresis for the comparing of the decision variable to the threshold to prevent the output signal from being set back and forth between the primary signal and the post-filtered signal when the energy ratio goes above and below the threshold level in a specified period of time.

25-28. (canceled)

29. A computer program product comprising a non-transitory storage medium including program code to be executed by processing circuitry of a decoder, whereby execution of the program code causes the decoder to perform operations comprising:
obtaining an energy estimation of at least a part of a frequency spectrum of a primary signal being reconstructed by the decoder;
obtaining an analysis of discontinuities in time domain that is caused by post-filtering of the primary signal;
generating a decision variable based on the energy estimation obtained and the analysis of discontinuities obtained;
comparing the decision variable to a threshold; and
setting the output signal to be the primary signal decoded or the post-filtered signal based on the comparing of the decision variable to the threshold.

30. (canceled)
